(19) United States
(12) Patent Application Publication
(10) Pub. No.: US 2010/0274571 A1
(43) Pub. Date: Oct. 28, 2010

(54) SYSTEM AND METHOD FOR GENERATING VEHICLE SERVICE LEADS AND VEHICLE SALES LEADS

(75) Inventors: Mike McFALL, Parkland, FL (US); Art DeLaurier, Parkland, FL (US); Dianne DeLaurier, Parkland, FL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Veretech Holdings Inc., New york, NY (US)

(21) Appl. No.: 12/429,802

(22) Filed: Apr. 24, 2009

(51) Int. Cl. G06Q 99/00

(52) U.S. Cl. 705/1.1; 705/14.4

(57) ABSTRACT

A system and method for generating leads associated with a vehicle operating on at least one computer device. The system and method including receiving vehicle profile data associated with the vehicle via a network, determining, using a programmed computer, an estimated cost of ownership of the vehicle based on at least the vehicle profile data, determining, using a programmed computer, an estimated value of the vehicle based on at least the vehicle profile data, and generating at least one of a vehicle service lead and a vehicle sales lead related to the vehicle.

### FIELD OF THE INVENTION

The present invention relates to a system and method for generating vehicle service leads and vehicle sales leads.

### BACKGROUND

Vehicle owners or custodians (e.g., fleet managers) may be interested in new vehicles. Several existing online systems provide data that enables a user to input information about a vehicle and receive an estimated trade-in value. Such determinations are often based on databases of information and estimates from prior sales of similar vehicles. While such systems are useful to users and often enable the online system to identify potential customers, such systems may be improved.

### SUMMARY OF THE INVENTION

When considering replacing their current vehicle, most consumers may perform extensive research using one or more online systems prior to visiting a car dealership. One question they may often try to answer is “should I replace my current vehicle now or hold onto it for another year.” Analysis directed to answering such a question may rely upon information (e.g., type of vehicle, model of vehicle, mileage associated with vehicle) from the consumer and/or information (e.g., vehicle value information, cost of repair information, cost of maintenance information) from one or more databases. The information collected and/or the results of such analysis may be useful to consumers and others that participate in vehicle sales transactions and/or vehicle service transactions.

At least one exemplary embodiment may provide a computer-implemented method for generating leads associated with a vehicle operating on at least one computer device. This embodiment may include receiving vehicle profile data associated with the vehicle via a network, determining, using a programmed computer, an estimated cost of ownership of the vehicle based on at least the vehicle profile data, determining, using a programmed computer, an estimated value of the vehicle based on at least the vehicle profile data, and generating a vehicle service lead related to the vehicle.

Embodiments may also provide a computer-implemented system for generating leads associated with a vehicle operating on at least one computer device. This embodiment may include a data source interface module configured to receive vehicle profile data associated with the vehicle via a network, a vehicle repair module configured to determine an estimated cost of ownership of the vehicle based on at least the vehicle profile data, a vehicle sales module configured to determine an estimated value of the vehicle based on at least the vehicle profile data, and a lead generation module configured to generate a vehicle service lead related to the vehicle.

Embodiments may also provide a computer-implemented system for generating leads associated with a vehicle operating on at least one computer device. This embodiment may include a data source interface module configured to receive vehicle profile data associated with the vehicle via a network, the data source interface module configured to receive user identification data, a vehicle repair module configured to determine an estimated cost of ownership of the vehicle based on at least the vehicle profile data, a vehicle sales module configured to determine an estimated value of the vehicle based on at least the vehicle profile data, and a lead generation module configured to generate a vehicle service lead related to the vehicle by transmitting the user identification data to a vehicle lead receipt system associated with a vehicle repair organization and is configured to support revenue generation based on the vehicle service lead.

### BRIEF DESCRIPTION OF THE DRAWINGS

The foregoing and other aspects and advantages will be better understood from the following detailed description of the invention with reference to the drawings, in which:

FIG. 1a illustrates a block diagram of a leads generation system, in accordance with exemplary embodiments;

FIG. 1b illustrates exemplary modules of a vehicle lead receipt system, a user system, and a leads generation system, in accordance with exemplary embodiments;

FIG. 2a illustrates an exemplary screen shot of vehicle profile data, in accordance with exemplary embodiments;

FIG. 2b illustrates an exemplary screen shot of additional vehicle profile data, in accordance with exemplary embodiments;

FIG. 2c illustrates an exemplary screen shot of additional vehicle profile data, in accordance with exemplary embodiments;

FIG. 3 illustrates an exemplary screen shot of additional vehicle profile data, in accordance with exemplary embodiments;

FIG. 4a illustrates an exemplary screen shot of vehicle purchase data, in accordance with exemplary embodiments;

FIG. 4b illustrates an exemplary screen shot of additional vehicle purchase data, in accordance with exemplary embodiments;

FIG. 5 illustrates an exemplary screen shot of user identification data, in accordance with exemplary embodiments;

FIG. 6a illustrates an exemplary screen shot of a cost of ownership determination, in accordance with exemplary embodiments;

FIG. 6b illustrates an exemplary screen shot comparing the estimated cost of ownership of a vehicle to the estimated value of the vehicle, in accordance with exemplary embodiments;

FIG. 7 illustrates an exemplary screen shot of a maintenance schedule, in accordance with exemplary embodiments; and

FIG. 8 illustrates a flowchart of a method for generating leads associated with a vehicle, in accordance with exemplary embodiments.

### DETAILED DESCRIPTION OF EMBODIMENTS OF THE INVENTION

In an exemplary embodiment, a vehicle leads system may operate to generate one or more leads (e.g., a vehicle repair lead, a vehicle sales lead) to be sold to a vehicle repair organization and/or a vehicle sales organization to generate revenue. For example, a user (e.g., a vehicle custodian) may use the vehicle leads system to input data (e.g., vehicle profile data, vehicle custodian identification data) associated with a vehicle. Based on at least the vehicle profile data, the vehicle leads system may determine an estimated cost of ownership of the vehicle and an estimated value of the vehicle. The estimated cost of ownership of the vehicle may indicate an estimated amount the user should expect to pay in maintenance and repair costs, depreciation costs, payment costs, etc., for the vehicle over a time period. The estimated value of the vehicle may indicate an estimated amount of the current value of the vehicle.

Based on the estimated amounts of the cost of ownership of the vehicle and the value of the vehicle, the user may input data that indicates the user's desire to repair the vehicle using the estimated cost of ownership of the vehicle as a baseline for repair fees or sale the vehicle using the estimated value of the vehicle as an offer for the sale of the vehicle. If, for example, the user indicates a desire to repair the vehicle, the vehicle leads system may sell the user's identification information and/or vehicle profile data information (e.g., one or more vehicle repair leads) to one or more vehicle repair organizations (e.g., a vehicle repair shop, a vehicle service department of a car dealership) for revenue. If, however, the user indicates a desire to sell the vehicle, the vehicle leads system may sell the user's identification information and/or vehicle profile data information (e.g., one or more vehicle sales leads) to one or more vehicle sales organizations (e.g., a car dealership, a used car dealership, a car auction company) for revenue. To determine the estimated cost of ownership of the vehicle and the estimated value of the vehicle, the vehicle leads system may access one or more proprietary databases communicatively coupled to the vehicle leads system.

A vehicle leads system may be configured to generate one or more vehicle repair leads for a vehicle service organization and/or one or more vehicle sales leads for a vehicle sales organization based on vehicle profile data, vehicle purchase data, service criteria data, and/or buyer criteria data. Vehicle profile data may include data that indicates one or more characteristics associated with a particular vehicle. For example, vehicle profile data may indicate the zip code of the location of the particular vehicle, make of the particular vehicle, the model of the particular vehicle, the vehicle identification number (VIN) of the particular vehicle, the year of manufacturer of the particular vehicle, the total mileage of the particular vehicle, the optional equipment of the particular vehicle, the physical condition of the particular vehicle, the mechanical condition of the particular vehicle, and/or any other data that may be used to indicate a characteristic of the particular vehicle.

Vehicle purchase data may include data that indicates the type of vehicle that a user is interested in purchasing. For example, vehicle purchase data may indicate the price of a vehicle, make of a vehicle, the model of a vehicle, the year of manufacture of a vehicle, the total mileage of a vehicle, the optional equipment of a vehicle, the physical condition of a vehicle, the mechanical condition of a vehicle, and/or any other data that may indicate the type of vehicle that a user is interested in purchasing.

Service criteria data may indicate one or more service requirements of a particular vehicle repair organization. For example, service criteria data may indicate service time limit data (e.g., a maximum amount of time that will be spent servicing a vehicle), vehicle specific service data (e.g., a make and model of one or more vehicles that a vehicle repair organization will not service, a make and model of one or more vehicles that a vehicle repair organization prefers to service) vehicle parts data (e.g., one or more vehicle parts that a vehicle repairs organization will not replace), and labor data (e.g., a maximum amount of mechanics designated to one service job).

Buyer criteria data may indicate a set of rules selected by a vehicle sales organization. For example, buyer criteria data may indicate a price control option (e.g., an estimated value is restricted to a maximum of a predetermined percentage (0 to 10%) above the average price provided in the Black Book, the National Automobile Dealers' Association (NADA) manual, the Kelley Blue Book, or the average wholesale price), vehicle specific criteria (e.g., the estimated value on each vehicle may be reduced or increased a percentage based upon the year, make, model, style, and/or color of the vehicle), historic vehicle issues (e.g., the estimated value of a vehicle may be reduced by an amount because of a history of particular maintenance issues), and price offset (e.g., the estimated value of a vehicle may be offset based on trade-in incentives and/or inventory incentives).

The vehicle leads system may be configured to determine the estimated cost of ownership of the vehicle based on the vehicle profile data and/or the service criteria data. The vehicle leads system may be configured to determine the estimated value of the vehicle based on the vehicle profile data and/or the buyer criteria data. The vehicle leads system may be configured to generate a vehicle repair lead by transmitting the user identification information to one or more vehicle repair organizations. The vehicle leads system may be configured to generate a vehicle sales lead by transmitting the user identification information to one or more vehicle sales organizations.

Implementers of systems that are configured to collect data that indicates one or more characteristics of a vehicle, the vehicle custodian's interest in purchasing a vehicle, the vehicle custodian's interest in repairing a vehicle, etc., from vehicle custodians (e.g., vehicle owners, vehicle users, fleet managers) may enter into financial relationships with one or more third parties (e.g., vehicle repair organizations, vehicle sales organizations, car dealerships, car repair shops) to share the data collected. A first type of financial relationship between the implementers of such systems and one or more of these third parties may dictate that the third parties receive a portion of the collected data for a fixed fee (e.g., $50 per vehicle service lead, $50 per vehicle sales lead). A second type of financial relationship between the implementers of such systems and one or more of these third parties may dictate that the third parties receive the collected data for a commission of any revenue generated based on the collected data (e.g., 1% of the revenue from the sale of a vehicle, 2% of the revenue from the service of a vehicle). In an alternative arrangement, one or more of these third parties may receive the collected data in exchange for the payment of a participation fee (e.g., a monthly participation fee of $1,500, a yearly participation fee of $12,000). In yet another alternative arrangement, one or more of these third parties may receive the collected data in exchange for the purchase of stake in a company operating a vehicle leads system.

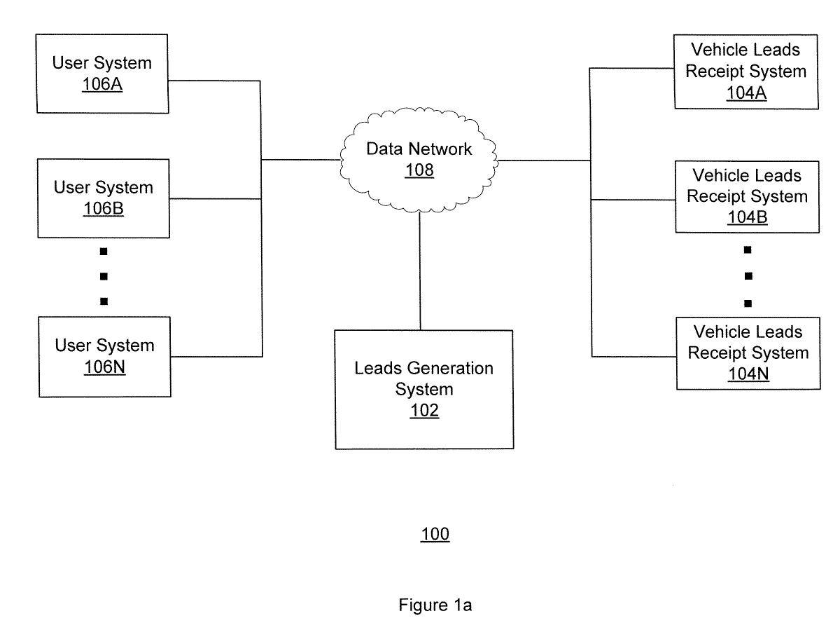

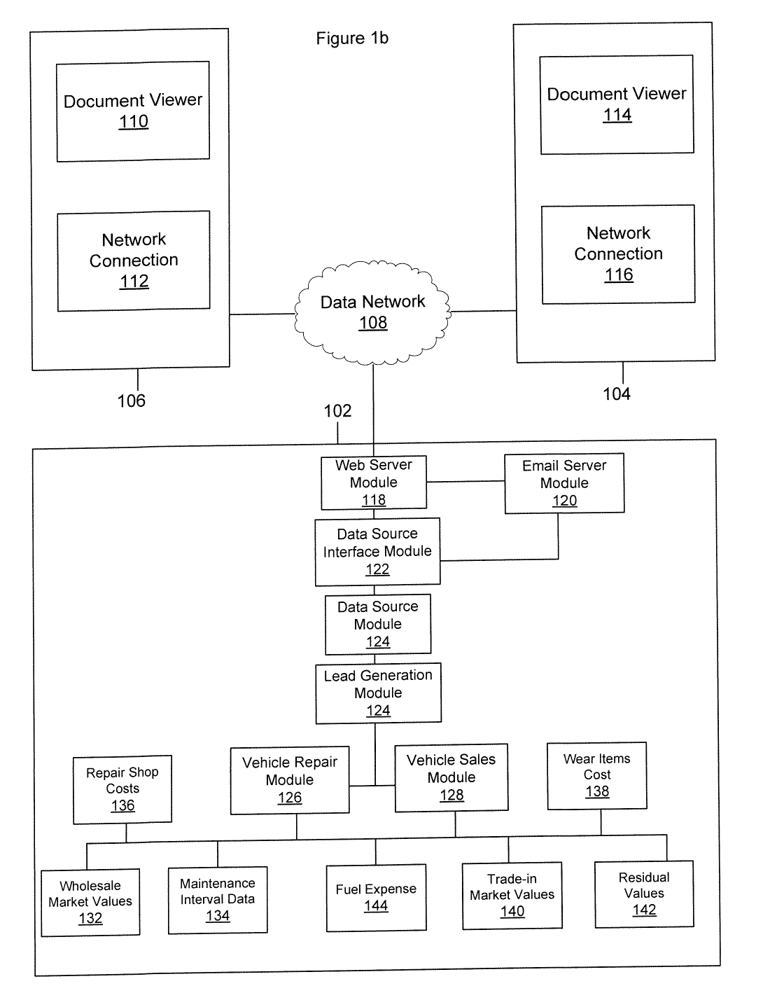

FIG. 1a illustrates a block diagram of a vehicle leads system 100, in accordance with exemplary embodiments. The vehicle leads system 100 may include one or more of the following: a leads generation system 102, one or more vehicle leads receipt systems 104, one or more user systems 106, and/or a data network 108.

The vehicle leads system 100 may be in communication with the data network 108. The data network 108 may include one or more of a local area network (LAN), a wide area network (WAN), the Internet, cellular networks, satellite networks, a passive optical network or other networks that permit the transfer and/or reception of data. The data network 108 may utilize one or more protocols of network clients. The data network 108 may also translate to or from other protocols to one or more protocols of network clients. In exemplary embodiments, the data network 108 may include one or more of the exemplary networks recited above operating as a stand-alone network or in cooperation with each other. Use of the term network herein is not intended to limit the network to a single network.

Leads generation system 102, one or more vehicle leads receipt systems 104, and/or one or more user systems 106 may be in communication with or have access to one or more data networks 108. For example, leads generation system 102, one or more vehicle leads receipt systems 104, and/or one or more user systems 106 may communicate with each other using one or more data networks 108.

A user, such as a dealer, buyer, and/or service mechanic, may interact with the leads generation system 102 using one or more vehicle leads receipt systems 104. A user, such as a vehicle custodian, a vehicle owner, and/or a vehicle seller, may interact with the leads generation system 102 using one or more user systems 106. The leads generation system 102, one or more vehicle leads receipt systems 104, and/or one or more user systems 106 may include, but are not limited to, a computer device or communications device including, e.g., a personal computer (PC), a workstation, a mobile device, a phone, a handheld PC, a personal digital assistant (PDA), a thin system, a fat system, network appliance, an Internet browser, a paging device, an alert device, a television, an interactive television, a receiver, a tuner, a high definition (HD) television, a video-on-demand (VOD) system, a server, a lap top, and/or any other device that is configured to communication and/or receive data.

One or more vehicle leads receipt systems 104 may include any device that is configured to generate and/or transmit service criteria data signals (e.g., service criteria data) and/or buyer criteria data signals (e.g., buyer criteria data) to the data network 108 and/or receive one or more vehicle service lead signals (e.g., vehicle service lead data) and/or one or more vehicle sales lead signals (e.g., vehicle sales lead data) from the data network 108.

One or more user systems 106 may include any device that is configured to generate and/or transmit vehicle profile data signals (e.g., vehicle profile data), vehicle purchase data signals (e.g., vehicle purchase data), and/or user identification signals (e.g., user identification data) to the data network 108 and/or receive one or more request signals for user input from the data network 108.

Leads generation system 102 may include any device that is configured to receive and/or process vehicle profile data signals, vehicle purchase data signals, user identification data signals, service criteria data signals, and/or buyer criteria data signals from the data network 108 and/or generate and/or transmit one or more request signals for user input, one or more vehicle service lead signals, and/or one or more vehicle sales leads to the data network 108. Leads generation system 102 may be configured to provide access to one or more vehicle service leads and/or one or more vehicle sales leads. For example, the leads generation system 102 may provide access to one or more vehicle service leads and/or one or more vehicle sales leads via email, snail mail, fax, instant message, text message, voice mail, and/or any other way that may provide access to one or more vehicle service leads and/or one or more vehicle sales leads. The leads generation system 102, one or more vehicle leads receipt systems 104, and/or one or more user systems 106 are discussed in further detail below.

FIG. 1b illustrates exemplary modules of a user system 106, a vehicle leads receipt system 104, and a leads generation system 102, in accordance with exemplary embodiments. As illustrated in FIG. 1b, the user system 106 may include a document viewer module 110 (which enables the user to access and/or generate data) and/or a network connection module 112 (which enables the user system 106 to access the data network 108 and/or the leads generation system 102). In various embodiments, a user that interacts with the user system 106 may include one or more consumers, one or more businesses, one or more vehicle dealers, one or more vehicle custodians, one or more vehicle sellers, etc.

As illustrated in FIG. 1b, the vehicle leads receipt system 104 may include a document viewer module 114 (which enables a user to access and/or generate data) and/or a network connection module 116 (which enables the leads receipt system 104 to access the data network 108 and/or the leads generation system 102). In various embodiments, a user that interacts with the vehicle leads receipt system 104 may include one or more vehicle sales men, one or more businesses, one or more service mechanics, one or more repair shops, one or more vehicle repair organizations, one or more vehicle sales organizations, etc.

To input and extract data from the lead generation system 102, an electronic document (e.g., a Web page) may be loaded in a conventional manner into the document viewer 110 and/or the document viewer 114. The document viewer 110 and/or the document viewer 114 may include any software application capable of viewing electronic documents and/or loading additional electronic documents associated with the original electronic document, such as through the use of a hypertext link (although not limited thereto).

For example, the document viewer 110 and/or the document viewer 114 may include a Web Browser, such as Netscape Communication's Navigator browser or Microsoft's Internet Explorer browser. One or more electronic documents may be loaded automatically when the document viewer 110 and/or the document viewer 114 are activated and/or may be opened into a viewer window by a user (e.g., a vehicle custodian, a vehicle sales man) from a file stored locally or remotely. For example, a user may load one or more electronic documents by inputting the web address of the one or more electronic documents into the web browser's command line.

The document viewer 110 and/or the document viewer 114 may be accessed by a user through the user system 106 and/or the vehicle leads receipt system 104, respectively. The document viewer 110 and/or the document viewer 114 may be connected to the Internet through the network connection 112 and/or the network connection 116, respectively. The network connection 112 and/or the network connection 116 may obtain access to one or more networks using one or more local telephone lines, one or more integrated services digital network (ISDN) connections, one or more digital subscriber line (DSL) connections, one or more direct network connections (e.g., Ethernet network connection), and/or one or more leased line connections. The network connection 112 and/or the network connection 116 may include a computer network that routes any data from the document viewer 110 and/or the document viewer 114 to the appropriate location on the Internet. It should be noted that this operation is well known to those of skill in the art. The network connection 112 and/or the network connection 116 may be configured to connect the document viewer 110 and/or the document viewer 114 to the web server module 118 of the lead generation system 102 through one or more well-known connection schemes, such as through the use of leased lines, respectively.

A user and/or a user system 106 may communicate with and/or transact with a user and/or a vehicle leads receipt system 104 via the data network 108 and/or the leads generation system 102. The leads generation system 102 may include one or more web server modules 118, one or more email server modules 120, one or more data source interface modules 122, one or more data source modules 124, one or more vehicle repair modules 126, one or more vehicle sales modules 128, one or more leads generation modules 130, one or more standardize and map to VIN modules 146, and/or one or more databases.

The web server module 118 may include software and/or hardware configured to transmit and/or process one or more data requests from the document viewer 110 and/or the document viewer 114. For example, web server module 118 may include one or more server applications, such as the Apache Web server application, etc. The web server module 118 may transmit an electronic document request and/or a data request from the document viewer 110 and/or the document viewer 114 to data source interface module 122. Data source interface module 122 may access data source 124.

Data source interface module 122 may include software and/or hardware configured to access data stored in the data source 124 and/or accessible by the data source 124. Data source module 124 may store and/or access data provided by one or more users interacting with user system 106 and/or one or more users interacting with vehicle leads receipt system 104. Data source module 124 may also store and/or access data generated by the one or more modules of the leads generation system 102.

After an electronic document is loaded into the document viewer 110 and/or the document viewer 114, a user interacting with user system 106 and/or a user interacting with vehicle leads receipt system 104 may input the appropriate data. In various embodiments, a user interacting with user system 106 and/or a user interacting with vehicle leads receipt system 104 may activate the transmission of the inputted data to the leads generation system 102 by activating a virtual button (e.g., a “Submit” button). In various embodiments, the activation of the transmission of the inputted data may include a hypertext transfer protocol (HTTP) request transmitted over the Internet using TCP/IP and/or a Secure Socket Layer (SSL). In an exemplary embodiment, the request may be routed through the network connection 112 or the network connection 116, the web server module 118, to the data source interface module 122. It should be noted that the details of HTTP operation in conjunction with TCP/IP and SSL are well known to those of ordinary skill in the art.

When a request (e.g., HTTP request) is received, the data source interface module 122 may access the data source module 124 to retrieve the requested data based upon the request signal from the document viewer 110 or the document viewer 114, store data received from the document viewer 110 or the document viewer 114, perform calculations using the received data, and/or any combination of these functions. In an exemplary embodiment, a common gateway interface (CGI) program that is well known to those of skill in the art, may be used to parse the data from the document viewer 110 or the document viewer 114. The CGI program may operate as an interface between the web server module 118, the data interface module 122, and/or the data source module 124 by executing one or more instructions. It should be noted that the interaction of web servers and CGI programs and the transmission of data there between is well known to those of ordinary skill in the art.

The CGI program may extract the data associated with an electronic document of the web server module 118 and retrieve the appropriate data from data source module 124. It should be noted that this may be accomplished in one or more ways known to those of ordinary skill in the art. For example, the CGI program may include a database access module associated with one or more commercially available relational database applications (e.g., Oracle, Sybase, SQL Server).

One or more data signals may be transmitted to or received from the data source module 124 based on the data signal transmitted by the document viewer 110 or the document viewer 114. The data source interface module 122 may then generate and/or transmit one or more data signals to the document viewer 110 or the document viewer 114 in response to one or more data requests via web server module 118. In various embodiments, the email server module 120 may include software and/or hardware configured to communicate with a user interacting with user system 106 and/or a user interacting with vehicle leads receipt system 104 using a known transmission protocol, such as simple mail transfer protocol (SMTP) and/or by outputting the data signals to one or more web sites that may the further process the one or more data signals.

The data source module 124 may include software and/or hardware configured to transmit data to, access data in, and/or receive data from a leads generation module 124, a vehicle repair module 126, and/or a vehicle sales module 128.

The vehicle repair module 126 may include software and/or hardware configured to determine and/or calculate an estimated cost of ownership associated with a particular vehicle. In an exemplary embodiment, the vehicle repair module 126 may be configured to calculate an estimated cost of ownership based on the vehicle profile data and/or the service criteria data associated with a particular dealer. An estimated cost of ownership may include an approximate amount of the total cost for a vehicle owner to maintain ownership of a properly functioning vehicle over a period of time. For example, an estimated cost of ownership of a 1993 Honda Accord over a twelve (12) month period may be $4,100 based on an estimated depreciation amount, an estimated vehicle payment amount, and/or an estimated maintenance-repair amount. In another example, an estimated cost of ownership of a 1972 Volkswagen Beetle over an eighteen (18) month period may be $9,323 based on an estimated depreciation amount, an estimated vehicle payment amount, and/or an estimated maintenance-repair amount. In yet another example, an estimated cost of ownership of a 2004 BMW 328xi over a twenty-four (24) month period may be $15,000 based on an estimated depreciation amount, an estimated vehicle payment amount, and/or an estimated maintenance-repair amount. Accordingly, the time period over which the estimated cost of ownership is determined and/or calculated may be varied (e.g., twelve (12) month period, eighteen (18) month period, twenty-four (24) month period) by a user based on personal preferences and/or the implementers of the leads generation system 102 based on design preferences.

Determining and/or calculating the estimated cost of ownership associated with a particular vehicle may include the vehicle repair module 126 determining and/or calculating an estimated depreciation amount. An estimated depreciation amount may be determined by subtracting the estimated value of the vehicle at the end of the time period from the current value of the vehicle. The estimated value of the vehicle will be discussed in further detail below.

Determining and/or calculating the estimated cost of ownership associated with a particular vehicle may also include the vehicle repair module 126 determining and/or calculating an estimated vehicle payment amount. An estimated vehicle payment amount may include an approximate total amount a vehicle custodian pays to a financing institution (e.g., bank) that financed the purchase of the vehicle over the time period. For example, a first vehicle custodian may pay $300 a month to a first financing institution for a first vehicle over a twelve (12) month period. Accordingly, the estimated vehicle payment amount over the twelve (12) month period may be $3,600. In another example, a second vehicle custodian may pay $500 a month to a second financing institution for a second vehicle over an eighteen (18) month period. Accordingly, the estimated vehicle payment amount over the eighteen (18) month period may be $9,000. In yet another example, a third vehicle custodian may pay $150 a month to a third financing institution for a third vehicle over a twenty-four (24) month period. Accordingly, the estimated vehicle payment amount over the twenty-four (24) month period may be $3,600.

Determining and/or calculating the estimated cost of ownership associated with a particular vehicle may also include the vehicle repair module 126 determining and/or calculating an estimated maintenance-repair amount. An estimated maintenance-repair amount may include the total cost of repairs and maintenance for a particular vehicle over a period of time according to one or more service schedule records associated with the vehicle and/or data associated with one or more proprietary databases communicatively coupled to the vehicle repair module 126. A service schedule record may include data that indicates a schedule of service (e.g., maintenance, repairs) according to the mileage of a vehicle, year of manufacture of a vehicle, make of a vehicle, model of a vehicle, and/or any other data indicator that may be used to determine a service schedule.

The vehicle repair module 126 may be configured to access one or more databases associated with the leads generation system 102. For example, the vehicle repair module 126 may access data stored in one or more whole sale market value databases 132 (e.g., storing data associated with the value of one or more vehicles sold at wholesale), one or more maintenance interval databases 134 (e.g., storing data associated with one or more service schedule records), one or more repair shop cost databases 136 (e.g., storing data associated with costs of one or more repair shops), one or more wear items cost databases 138 (e.g., storing data associated with costs of replacing one or more wear items or parts), one or more trade-in market value databases 140 (e.g., storing data associated with the market trade-in value of one or more vehicles), one or more residual value databases 142 (e.g., storing data associated with the residual value of one or more vehicles), and/or one or more fuel expense data bases 144 (e.g., storing data associated with the cost of fueling one or more vehicles).

For example, the vehicle repair module 126 may be configured to access data in and/or receive data from one or more databases associated with Black Book® for vehicle appraisal data and/or vehicle pricing data, one or more databases associated with Motor Information Systems for general vehicle data, vehicle repair data, and/or vehicle parts and labor estimation data, one or more databases associated with the FleetCross® for general vehicle data, vehicle repair data, and/or vehicle parts and labor estimation data, one or more databases associated with Veretech Holdings and/or the Activator™ for vehicle trade-in value data, and/or any other database associated with the implementers of the leads generation system 102.

Based on an estimated depreciation amount, an estimated vehicle payment amount, an estimated maintenance-repair amount, and/or any other amount that may be used to determine costs, the vehicle repair module 126 may determine and/or calculate the estimated cost of ownership of a particular vehicle.

The vehicle sales module 128 may include software and/or hardware configured to determine and/or calculate an estimated value associated with a particular vehicle. In an exemplary embodiment, the vehicle sales module 128 may be configured to determine and/or calculate an estimated value based the vehicle profile data and/or the buyer criteria data associated with a particular user interacting with the vehicle leads receipts system 104 as explained below.

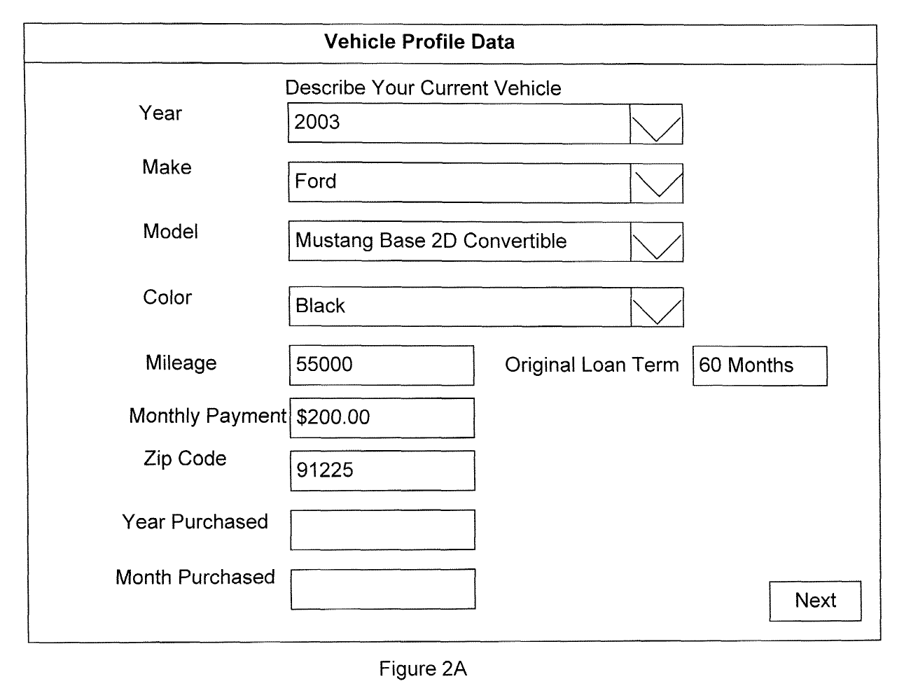

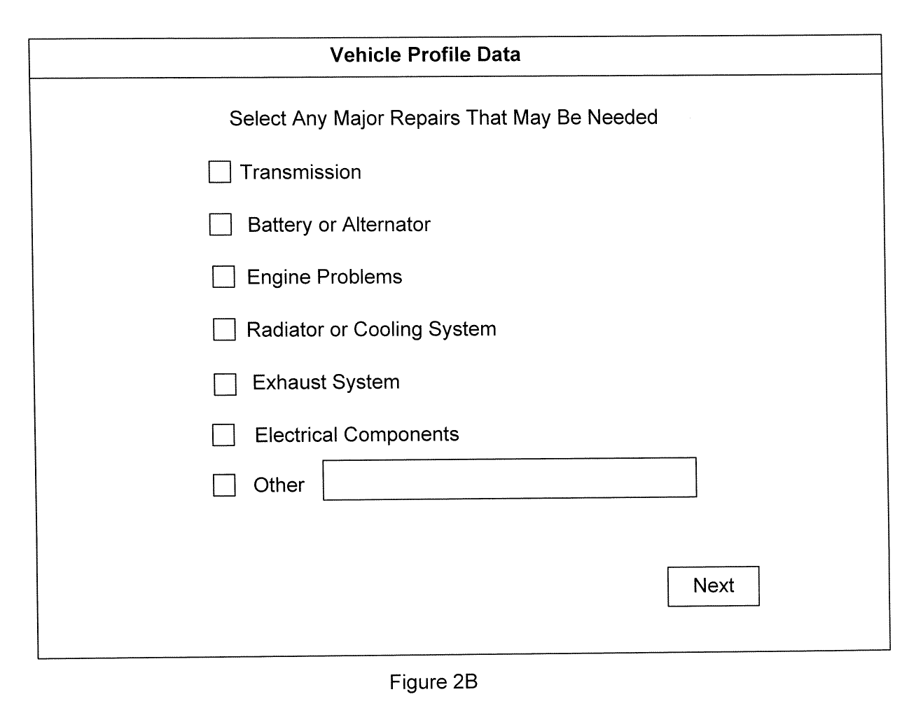

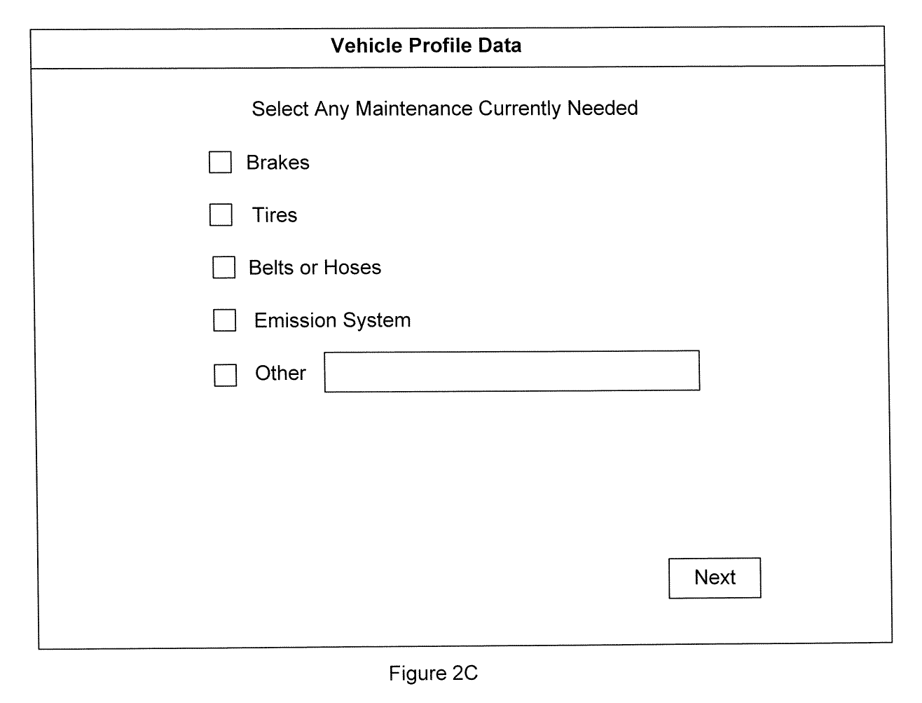

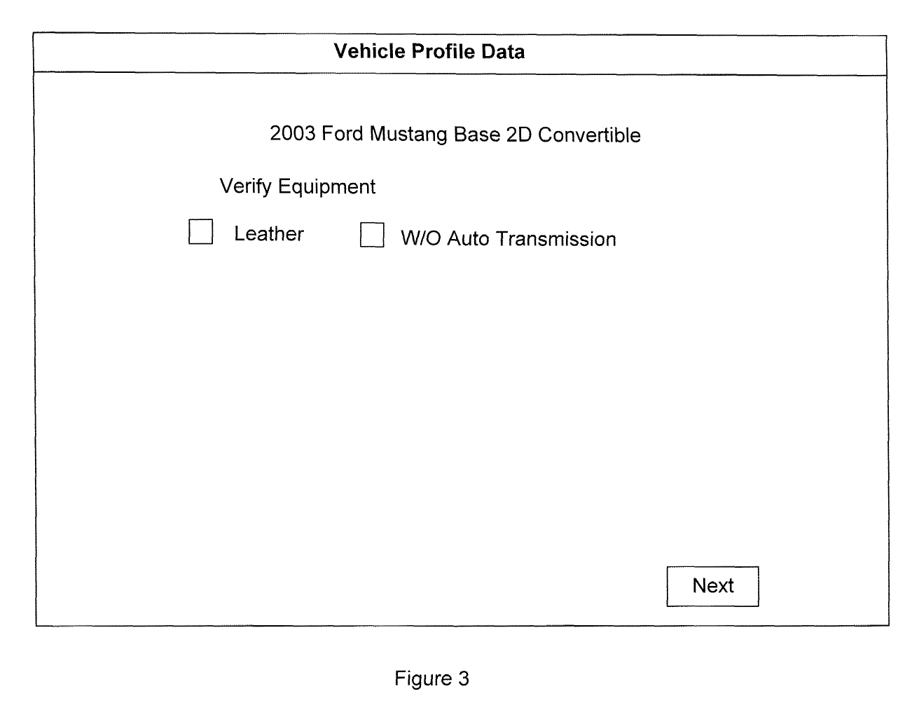

As shown also shown in FIGS. 2-3, a user interacting with a user system 106 may input vehicle profile data, such as the zip code of the location of the particular vehicle, make of the particular vehicle, the model of the particular vehicle, the vehicle identification number (VIN) of the particular vehicle, the year of manufacturer of the particular vehicle, the total mileage of the particular vehicle, the optional equipment of the particular vehicle, the physical condition of the particular vehicle, the mechanical condition of the particular vehicle, and/or any other data that may be used to indicate a characteristic of the particular vehicle. While the make, model, style, and year of the vehicle may also be provided, this vehicle profile data may be determined from one or more vehicle records associated with the vehicle using the VIN. In various embodiments, vehicle profile data may be accessed in one or more databases associated with the leads generation system 102. For example, the vehicle profile data may be accessed in a database that provides one or more VINs from one or manufacturers and the associated vehicle profile data. It should also be noted vehicle profile data may be accessed in one or more state department of motor vehicle databases.

Vehicle profile data may include data that indicates the “trim level” of the vehicle (e.g., the optional equipment or option packages associated with the vehicle at the time of manufacturing). A user interacting with a user system 106 may provide vehicle profile data that indicates the number of miles associated with a vehicle. A user interacting with a user system 106 may provide vehicle profile data that indicates the zip code of the location of a vehicle. Accordingly, the zip code may used to associate the vehicle with a user interacting with a vehicle leads receipt system 106 located in the same zip code. The zip code of one or more users may be stored in the data source 124.

The vehicle sales module 128 may be configured to access one or more databases associated with the leads generation system 102 to determine and/or calculate the estimated value of a particular vehicle. For example, the vehicle sales module 128 may access data stored in one or more whole sale market value databases 132, one or more maintenance interval databases 134, one or more repair shop cost databases 136, one or more wear items cost databases 138, one or more trade-in market value databases 140, one or more residual value databases 142, and/or one or more fuel expense data bases 144.

For example, the vehicle sales module 128 may be configured to access data in and/or receive data from one or more databases associated with Black Book® for vehicle appraisal data and/or vehicle pricing data, one or more databases associated with Motor Information Systems for general vehicle data, vehicle repair data, and/or vehicle parts and labor estimation data, one or more databases associated with the FleetCross® for general vehicle data, vehicle repair data, and/or vehicle parts and labor estimation data, one or more databases associated with Veretech Holdings and/or the Activator™ for vehicle trade-in value data, and/or any other database associated with the implementers of the leads generation system 102.

The vehicle sales module 128 may determine and/or calculate the estimated value of a vehicle by comparing the vehicle profile data to historical value data associated with one or more other vehicles that are similar to the vehicle. For example, the vehicle sales module 128 may compare the vehicle profile data to one or more similar vehicles (e.g., similar in make, similar in model, similar in mileage, similar in year of manufacture, similar in option equipment) sold at a whole sale auction or traded-in to determine a preliminary estimated value of the vehicle. The vehicle sales module 128 may increase the estimated value (e.g., preliminary estimated value) by an amount based on the optional equipment. The vehicle sales module 128 may decrease the estimated value by an amount based on excess mileage (e.g., mileage over the average mileage of similar vehicles). The vehicle sales module 128 may decrease the estimated value by an amount based on one or more physical condition flaws (e.g., relative to the physical condition of similar vehicles) and/or one or more mechanical condition flaws (e.g., relative to the mechanical condition of similar vehicles).

It should be noted that other factors may be considered, analyzed, and/or applied to aid a user in determining to sale a vehicle or repair or vehicle. For example, safety information (e.g., known safety issues), insurance information (e.g., cost of insurance), environmental impact information (e.g., information indicating a level of environmental friendliness of a vehicle), crashworthiness information (e.g., information indicating the ability of the structure of a vehicle to protect one or more occupants), and/or any other information that may be used to aid a user in determining to sale a vehicle or repair a vehicle.

The lead generation module 130 may include software and/or hardware configured to generate, provide access to, and/or sell a vehicle repair lead based on the estimated cost of ownership associated with a vehicle. For example, the lead generation module 130 may be configured to generate and/or provide access to a vehicle repair lead by transmitting the user identification information to one or more vehicle repair organizations. The lead generation module 130 may also include software and/or hardware configured to generate, provide access to, and/or sell a vehicle sales lead based on the estimated value associated with a vehicle. For example, the lead generation module 130 may be configured to generate and/or provide access to a vehicle sales lead by transmitting the user identification information to one or more vehicle sales organizations.

It should be noted that the functionalities of generating, providing access to, and/or selling vehicle sales lead may be described in U.S. patent application Ser. No. 10/640,852 entitled “Lead Generation System Using Buyer Criteria,” filed on Aug. 14, 2003, now U.S. Pat. No. 7,050,982, which are incorporated by reference herein in their entirety.

FIG. 2a illustrates an exemplary screen shot of vehicle profile data, in accordance with exemplary embodiments. As illustrated in FIG. 2a, a user interacting with a user system 106 may be prompted to input vehicle profile data. For example, a user may be prompted to input the year of manufacture of a particular vehicle (e.g., 2003), the make of a particular vehicle (e.g., Ford), the model of a particular vehicle (e.g., Mustang Base 2D Convertible), the color of a particular vehicle (e.g., Black), the mileage of a particular vehicle (e.g., 55,000 miles), the monthly payment of a particular vehicle, the zip code of the location of a particular vehicle (e.g., 91225), the year the vehicle was purchased, the month the vehicle was purchased, and/or the original loan term (e.g., 60 months) using the user system 106. In various embodiments, the user may navigate to one or more other electronic pages by activating a navigation virtual button (e.g., “Next” button).

FIG. 2b illustrates an exemplary screen shot of additional vehicle profile data, in accordance with exemplary embodiments. As illustrated in FIG. 2b, a user interacting with a user system 106 may be prompted to input additional vehicle profile data. For example, a user may be prompted to input one or more repairs that may be needed for the vehicle, such as: transmission repairs, battery repairs, alternator repairs, engine repairs, radiator repairs, cooling system repairs, exhaust system repairs, electrical component repairs, and/or one or more other repairs using the user system 106. In various embodiments, the user may navigate to one or more other electronic pages by activating a navigation virtual button (e.g., “Next” button).

FIG. 2c illustrates an exemplary screen shot of additional vehicle profile data, in accordance with exemplary embodiments. As illustrated in FIG. 2c, a user interacting with a user system 106 may be prompted to input additional vehicle profile data. For example, a user may be prompted to input maintenance that may be needed for the vehicle, such as: brakes maintenance, tires maintenance, belts maintenance, hoses maintenance, emission system maintenance, and/or any other maintenance using the user system 106. In various embodiments, the user may navigate to one or more other electronic pages by activating a navigation virtual button (e.g., “Next” button).

FIG. 3 illustrates an exemplary screen shot of additional vehicle profile data, in accordance with exemplary embodiments. As illustrated in FIG. 3, a user interacting with a user system 106 may be prompted to input additional vehicle profile data. For example, a user may be prompted to input an equipment package associated with a particular vehicle (e.g., Leather package, w/o Auto Transmission package) using the user system 106. In various embodiments, the user may navigate to one or more other electronic pages by activating a navigation virtual button (e.g., “Next” button).

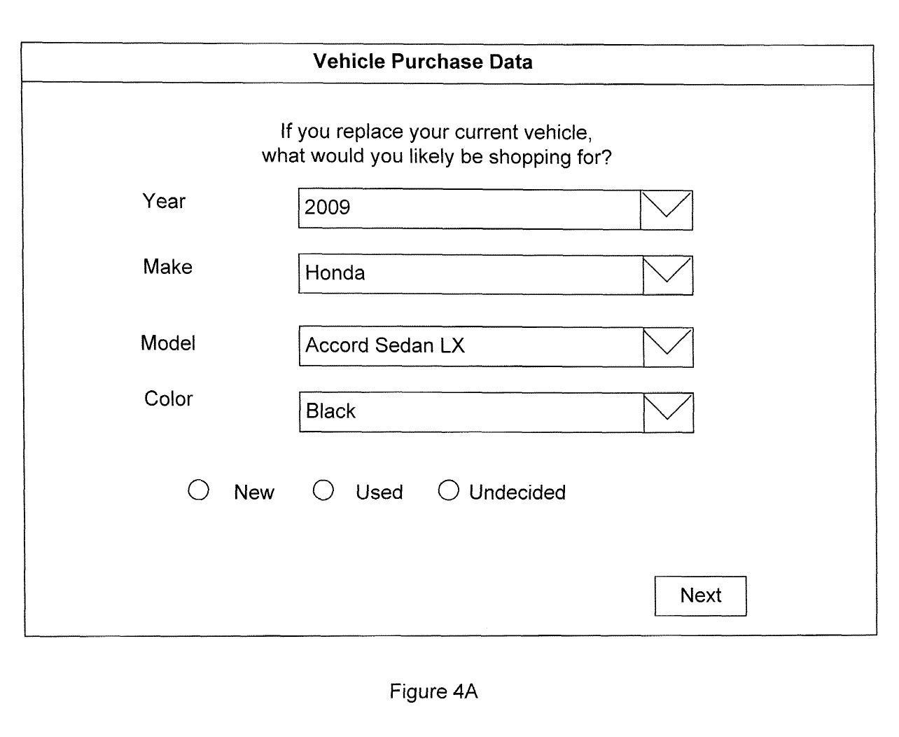

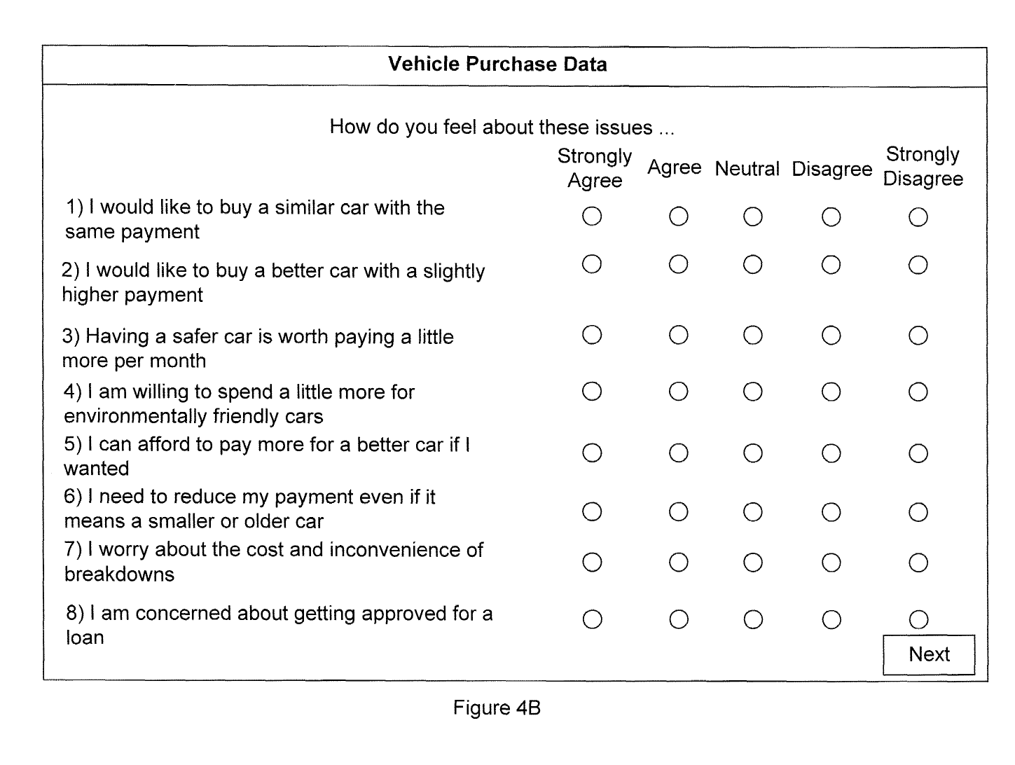

FIG. 4a illustrates an exemplary screen shot of vehicle purchase data, in accordance with exemplary embodiments. As illustrated in FIG. 4a, a user interacting with a user system 106 may be prompted to input vehicle purchase data that may be used to generate one or more vehicle sale leads. For example, a user may be prompted to input the year of manufacture of a vehicle the user is interested in purchasing (e.g., 2009), a make of a vehicle the user is interested in purchasing (e.g., Honda), a model of a vehicle the user is interested in purchasing (e.g., Accord Sedan LX), and/or a color of a vehicle the user is interested in purchasing (e.g., Black) using the user system 106. In various embodiments, the user may navigate to one or more other electronic pages by activating a navigation virtual button (e.g., “Next” button).

FIG. 4b illustrates an exemplary screen shot of additional vehicle purchase data, in accordance with exemplary embodiments. As illustrated in FIG. 4b, a user interacting with a user system 106 may be prompted to input additional vehicle purchase data that may be used to generate one or more vehicle sale leads. For example, a user may be prompted to input one or more ways the user feels about one or more issues illustrated in FIG. 4b using the user system 106. In various embodiments, the user may navigate to one or more other electronic pages by activating a navigation virtual button (e.g., “Next” button).

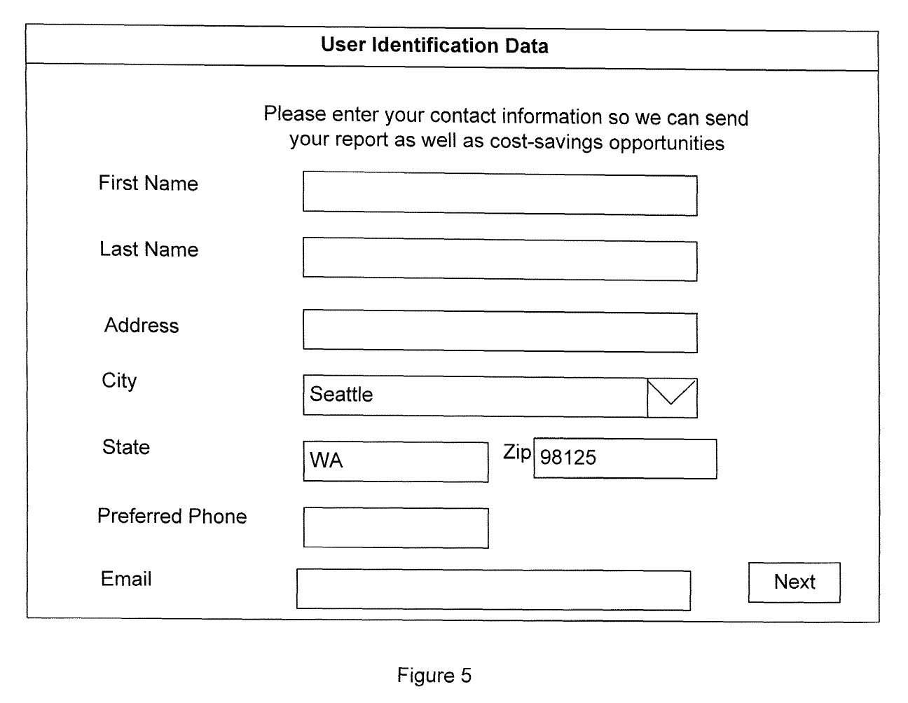

FIG. 5 illustrates an exemplary screen shot of vehicle owner identification data, in accordance with exemplary embodiments. As illustrated in FIG. 5, a user interacting with a user system 106 may be prompted to input user identification data that may be transmitted to one or more vehicle sales organizations and/or one or more vehicle repair organizations. For example, a user may be prompted to input a first name, a last name, a street address, a city, a state, a zip code, a preferred telephone number, and/or an email address as user identification data using a user system 106. In various embodiments, the user may navigate to one or more other electronic pages by activating a navigation virtual button (e.g., “Next” button).

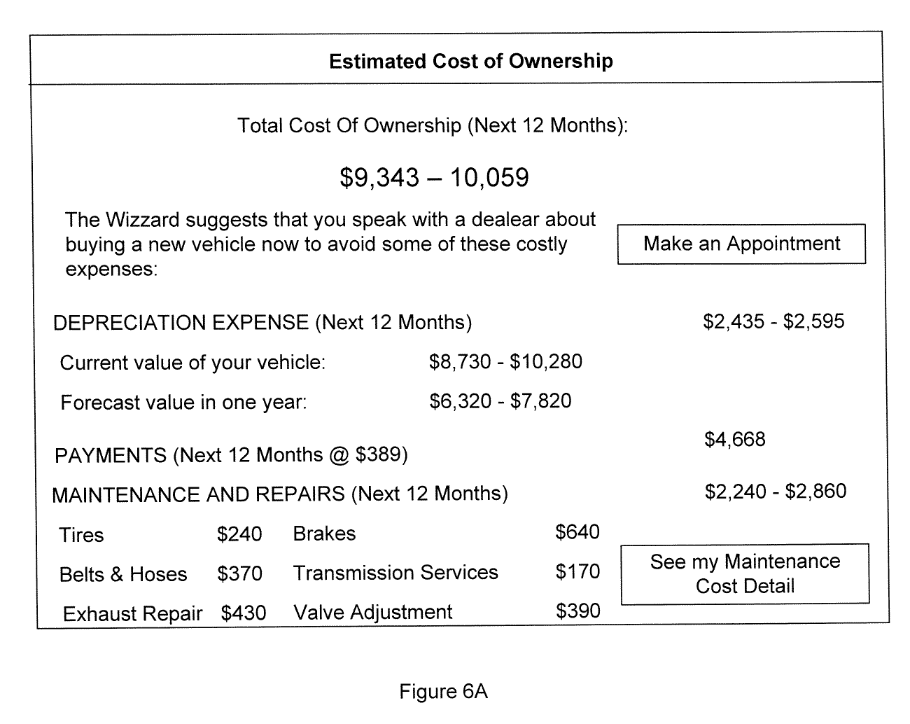

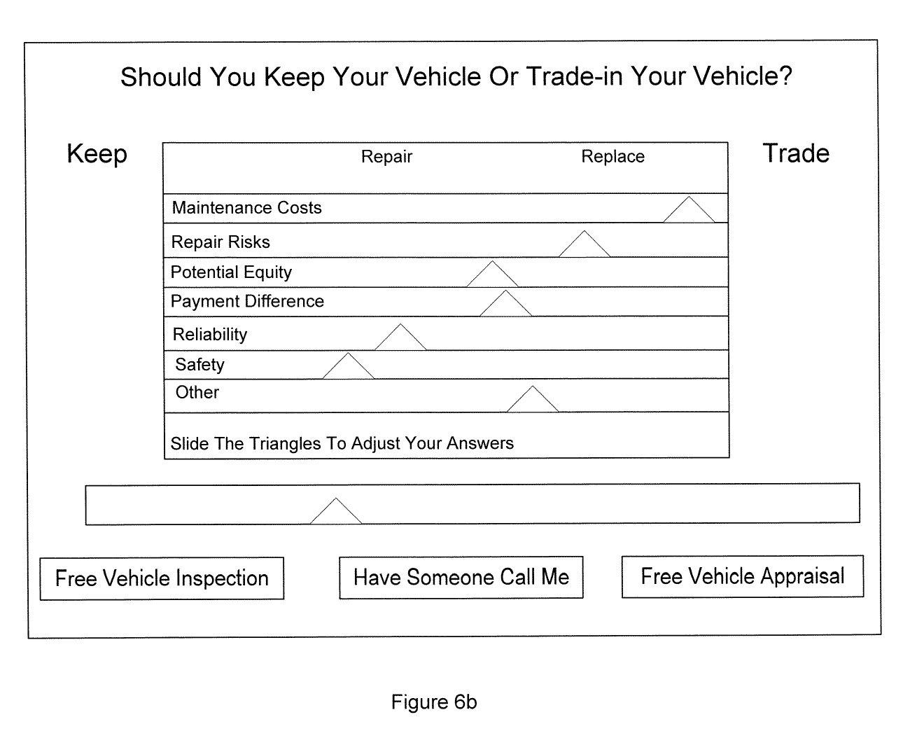

FIG. 6a illustrates an exemplary screen shot of an estimated cost of ownership determination, in accordance with exemplary embodiments. As illustrated in FIG. 6a, the leads generation system 102 may output to a user interacting with a user system 106 an estimation of the total cost of ownership over a twelve (12) month period of time (e.g., $9,343-$10,059), a depreciation expense (e.g., $2,435-$2,595), an estimated value of the vehicle (e.g., $8,730-$10,280), a forecast value of the vehicle in one year (e.g., $6,320-$7,820), a vehicle payment amount over one year (e.g., $4,668), and/or a maintenance-repair amount (e.g., $2,240-$2,860) via the user system 106. In various embodiments, the user may navigate to one or more other electronic pages associated with making an appointment with one or more vehicle sales organizations by activating a navigation virtual button (e.g., “Make an Appointment” button). In various embodiments, the user may navigate to one or more other electronic pages associated with details of the maintenance costs by activating a navigation virtual button (e.g., “See my Maintenance Cost Detail” button).

FIG. 6b illustrates an exemplary screen shot comparing the estimated cost of ownership of a vehicle to the estimated value of the vehicle, in accordance with exemplary embodiments. As illustrated in FIG. 6b, the leads generation system 102 may output data that compares an estimated cost of ownership of a vehicle to the estimated value of the vehicle to aid in determining whether to repair a vehicle or trade in a vehicle.

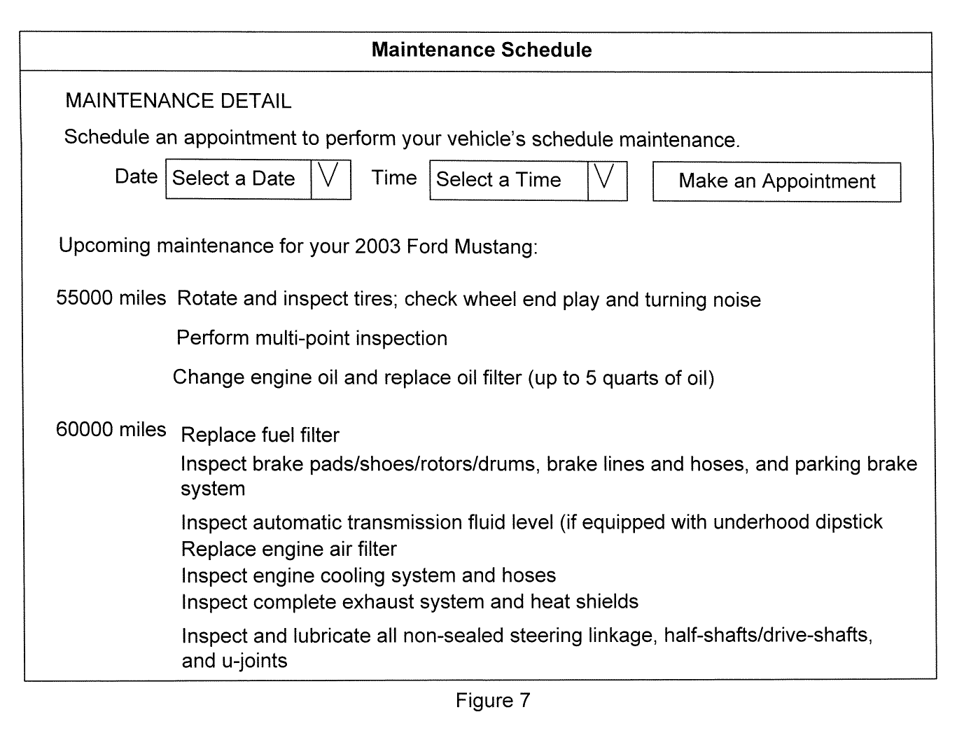

FIG. 7 illustrates an exemplary screen shot of a maintenance schedule, in accordance with exemplary embodiments. As illustrated in FIG. 7, the leads generation system 102 may output to a user interacting with a user system 106 one or more details associated with the determination and/or calculation of the estimated maintenance-repair amount via the user system 106. In various embodiments, the user may navigate to one or more other electronic pages associated with making an appointment with one or more vehicle repair organizations by activating a navigation virtual button (e.g., “Make an Appointment” button).

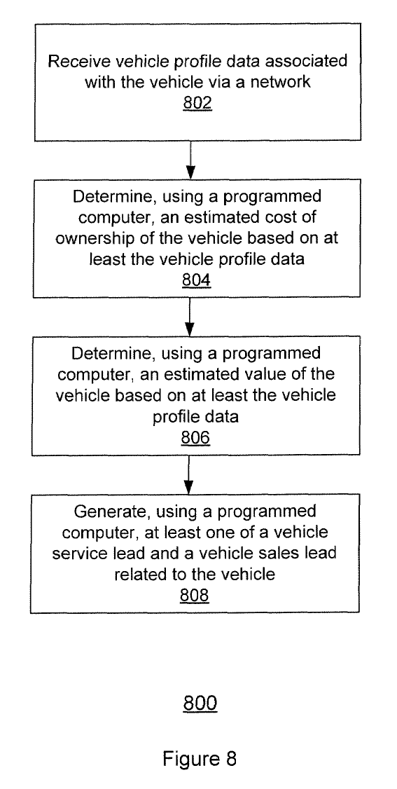

FIG. 8 illustrates a flowchart of a method for generating leads associated with a vehicle, in accordance with exemplary embodiments. This exemplary method is provided by way of example. The method 800 shown in FIG. 8 can be executed or otherwise performed by one or a combination of various systems. The method 800 is described below as carried out by the leads generation system 102 shown in FIG. 1 by way of example, and various elements of the leads generation system are referenced in explaining the example method of FIG. 8. Each block shown in FIG. 8 represents one or more processes, methods, or subroutines carried in the exemplary method 800. Referring to FIG. 8, the exemplary method 800 may begin at block 802.

In block 802, the method 800 may include receiving vehicle profile data associated with the vehicle. In an exemplary embodiment, the data source interface module 122 may receive vehicle profile data from a user system 106 via a data network 108. The method 800 may continue to block 804.

In block 804, the method 800 may include determining an estimated cost of ownership of the vehicle based one at least the vehicle profile data. In an exemplary embodiment, the vehicle service module 126 may determine and/or calculate the estimated cost of ownership based on the vehicle profile data. The method 800 may continue to block 806.

In block 806, the method 800 may include an estimated value of the vehicle based on at least the vehicle profile data. In an exemplary embodiment, the vehicle sales module 128 may determine and/or calculate the estimated value based on the vehicle profile data. The method 800 may continue to block 808.

In block 808, the method 800 may include generating at least one of a vehicle service lead and a vehicle sales lead related to the vehicle. In an exemplary embodiment, the lead generation module 130 may generate at least one of the vehicle service lead and the vehicle sales lead. The method 800 may then end.

By way of a non-limiting example, a user interacting with a user system 106 may be prompted to record an observation of the condition of the vehicle on a questionnaire. The questionnaire may electronically emulate the process of a used car appraisal that is traditionally performed in person at a vehicle dealership. One or more condition flaws may be noted, whether physical or mechanical. In various embodiments, the one or more condition flaws may reduce the current wholesale market value of the vehicle. For example, as each portion of a vehicle is reviewed, a user interacting with a user system 106 may be prompted to comment on a condition, such as inputting “like new,” “fair,” or “damaged.” If, for example, the user inputs that an item associated with the condition of a vehicle as being something other than “like new,” the questionnaire may expand inquire more thoroughly as to condition flaws.

By way of a non-limiting example, the lead generation system 102 and/or vehicle leads receipt system 104 may generate an offer price or estimated value for the vehicle. Lead generation system 102 may then transmit the offer price to a user interacting with a user system 106 via the user system 106, by an email using the email server module 120, and/or by any other communication method (e.g., text message, fax, instant message, postal service). In various embodiments, the offer price may take the form of a demand certificate.

In various embodiments, prior to submitting an offer price to a user interacting with a vehicle leads receipt system 106, leads generation system 102 may refine the offer price using one or more of buyer criteria (e.g., buyer criteria data). In various embodiments, buyer criteria data may be stored in the data source 124 in a profile for each user (along with service criteria data for a user).

For example, the buyer criteria data may include a price control option, where pricing is restricted to a maximum of some predetermined percentage (preferably 0 to 10%) above the average price provided in the Black Book, NADA, the Kelley Blue Book, or the average wholesale price. This feature is further illustrated in Table 1.

TABLE 1

| Appraisal Value: | | Discount: | |
|---|---|---|---|
| From $5,000 | to $10,000 | reduce price by | $500 |
| From $10,001 | to $18,000 | reduce price by | $700 |
| From $18,001 | to $25,000 | reduce price by | $1,000 |
| From $25,001 | to $40,000 | reduce price by | $1,500 |

Vehicle specific buyer criteria may also be used. For example, the average wholesale (auction) price on each vehicle may be reduced or increased a percentage based upon the Year, Make, Model, Style, and/or Color of the vehicle. These pricing rules will be used in addition to the general rules noted above.

In various embodiments, vehicles associated with one or more vehicles with a trend of maintenance problems, repair problems, depreciation problems, etc., may also be excluded from the aforementioned price adjustments and/or denied an offer/value altogether. Such problems may include, for example, vehicles that have been used for commercial purposes, vehicles used by tradesmen, vehicles used to carry cargo, vehicles older than a 1994 model year, vehicles with major damage or excessive condition flaws, vehicles with major hail damage or rust, vehicles that have sustained previous damage exceeding $2,500, vehicles with excessive mechanical problems, vehicles with faulty or inoperative odometers, and/or vehicles that have branded or salvage titles.

An offset for state sales tax may also be used as buyer criteria for modifying the offer to a user interacting with a user system 106. For example, state tax tables may be used to show the difference between the tax on the purchase of a new car and the purchase of a used car. This difference may also be used to modify the offered value for the used vehicle accordingly. The estimated value may be provided and the tax savings for that state may also be shown.

It should be noted that the vehicle leads system described herein may operate as a stand system that determines the cost of ownership and/or generates vehicle service leads (e.g., service appointments) or vehicle sales leads based on that determination.

The previous description is intended to convey an understanding of the embodiments described by providing a number of exemplary embodiments and details involving systems and methods for generating leads associated with a vehicle. It should be appreciated, however, that the present invention is not limited to these specific exemplary embodiments and details. It is further understood that one possessing ordinary skill in the art, in light of known systems and methods, would appreciate the use of the invention for its intended purposes and benefits in any number of alternative embodiments, depending on specific design and other needs.

The description above describes elements of a network that may include one or more modules, some of which are explicitly shown in the figures, others that are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

The description below also describes physical and logical elements of a network and/or a system, some of which are explicitly shown in figures, others that are not. The inclusion of some physical elements of a network and/or a system may help illustrate how a given network and/or system may be modeled. It should be noted, however, that all illustrations are purely exemplary and that the network and/or system scheme described herein may be performed on different varieties of networks and/or systems which may include different physical and logical elements.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof.

Although this invention has been described with reference to particular embodiments, it will be appreciated that many variations may be resorted to without departing from the spirit and scope of this invention. For example, while the present invention has been described in connection with lead generation from the valuation of automobiles, it is not limited thereto and may include any vehicle that is capable of being valued using historical sales data and specific vehicle history, such as motorcycles, mobile homes, boats and personal watercraft. Also the system of the present invention may be implemented over a local network or virtual private network or any internet worked system, and is not limited to the Internet.

1. A computer-implemented method for generating leads associated with a vehicle operating on at least one computer device, the computer-implemented method comprising:
receiving vehicle profile data associated with the vehicle via a network;
determining, using a programmed computer, an estimated cost of ownership of the vehicle based on at least the vehicle profile data;
determining, using a programmed computer, an estimated value of the vehicle based on at least the vehicle profile data; and
generating a vehicle service lead related to the vehicle.

2. The computer-implemented method of claim 1, further comprising receiving user identification data.

3. The computer-implemented method of claim 1, wherein the vehicle profile data comprises one or more selected from the group consisting of make data, model data, vehicle identification number data, year data, mileage data, optional equipment data, physical condition data, and mechanical condition data.

4. The computer-implemented method of claim 1, further comprising receiving at least one of service criteria data and buyer criteria data.

5. The computer-implemented method of claim 4, wherein the service criteria data comprises one or more selected from the group consisting of service limit data, vehicle specific service data, vehicle parts data, and labor data.

6. The computer-implemented method of claim 4, wherein the buyer criteria data comprises one or more selected from the group consisting of price control data, vehicle specific criteria data, historic vehicle issues data, and price offset data.

7. The computer-implemented method of claim 1, wherein determining the estimated cost of ownership of the vehicle further comprises determining an estimate of a depreciation expense amount.

8. The computer-implemented method of claim 1, wherein determining the estimated cost of ownership of the vehicle further comprises determining an estimate of a vehicle payment amount.

9. The computer-implemented method of claim 1, wherein determining the estimated cost of ownership of the vehicle further comprises determining an estimate of a maintenance-repair amount.

10. The computer-implemented method of claim 1, wherein determining the estimated value of the vehicle further comprises comparing the vehicle profile data to historical value data associated with one or more other vehicles that are similar to the vehicle.

11. The computer-implemented method of claim 2, wherein generating the vehicle service lead further comprises transmitting the user identification data to one or more vehicle lead receipt systems associated with one or more vehicle repair organizations.

12. The computer-implemented method of claim 1, further comprising generating a vehicle sales lead related to the vehicle.

13. The computer-implemented method of claim 12, further comprising generating at least one of the vehicle service lead and the vehicle sales lead based on user input that indicates user interest.

14. The computer-implemented method of claim 12, wherein generating the vehicle sales lead further comprises transmitting the user identification data to one or more vehicle lead receipt systems associated with one or more vehicle sales organizations.

15. The computer-implemented method of claim 12, further comprising generating revenue based on at least one of the vehicle service lead and the vehicle sales lead.

16. The computer-implemented method of claim 15, wherein generating revenue further comprises selling at least one of the vehicle service lead and the vehicle sales lead to one or more third parties.

17. A computer-implemented system for generating leads associated with a vehicle operating on at least one computer device, the computer-implemented system comprising:
a data source interface module configured to receive vehicle profile data associated with the vehicle via a network;
a vehicle repair module configured to determine an estimated cost of ownership of the vehicle based on at least the vehicle profile data;
a vehicle sales module configured to determine an estimated value of the vehicle based on at least the vehicle profile data; and
a lead generation module configured to generate a vehicle service lead related to the vehicle.

18. The computer-implemented system of claim 17, wherein the data source interface module is further configured to receive user identification data.

19. The computer-implemented system of claim 17, wherein the vehicle profile data comprises one or more selected from the group consisting of make data, model data, vehicle identification number data, year data, mileage data, optional equipment data, physical condition data, and mechanical condition data.

20. The computer-implemented system of claim 17, wherein the data source interface module is further configured to receive at least one of service criteria data and buyer criteria data.

21. The computer-implemented system of claim 20, wherein the service criteria data comprises one or more selected from the group consisting of service limit data, vehicle specific service data, vehicle parts data, and labor data.

22. The computer-implemented system of claim 20, wherein the buyer criteria data comprises one or more selected from the group consisting of price control data, vehicle specific criteria data, historic vehicle issues data, and price offset data.

23. The computer-implemented system of claim 17, wherein the vehicle repair module is configured to determine the estimated cost of ownership of the vehicle by determining an estimate of a depreciation expense amount.

24. The computer-implemented system of claim 17, wherein the vehicle repair module is configured to determine the estimated cost of ownership of the vehicle by determining an estimate of a vehicle payment amount.

25. The computer-implemented system of claim 17, wherein the vehicle repair module is configured to determine the estimated cost of ownership of the vehicle by determining an estimate of a maintenance-repair amount.

26. The computer-implemented system of claim 17, wherein the vehicle sales module is configured to determine the estimated value of the vehicle by comparing the vehicle profile data to historical value data associated with one or more other vehicles that are similar to the vehicle.

27. The computer-implemented system of claim 18, wherein the lead generation module is configured to generate the vehicle service lead by transmitting the user identification data to one or more vehicle lead receipt systems associated with one or more vehicle repair organizations.

28. The computer-implemented system of claim 18, wherein the lead generation module is further configured to generate a vehicle sales lead related to the vehicle.

29. The computer-implemented system of claim 28, wherein the lead generation module is further configured to generate at least one of the vehicle service lead and the vehicle sales lead based on user input that indicates user interest.

30. The computer-implemented system of claim 28, wherein the lead generation module is configured to generate the vehicle sales lead by transmitting the user identification data to one or more vehicle lead receipt systems associated with one or more vehicle sales organizations.

31. The computer-implemented system of claim 28, wherein the lead generation module is further configured to support generation of revenue based on at least one of the vehicle service lead and the vehicle sales lead.

32. The computer-implemented system of claim 31, wherein the lead generation module is configured to support revenue generation by supporting the sell of at least one of the vehicle service lead and the vehicle sales lead to one or more third parties.

33. A computer-implemented system for generating leads associated with a vehicle operating on at least one computer device, the computer-implemented system comprising:
a data source interface module configured to receive vehicle profile data associated with the vehicle via a network;
the data source interface module configured to receive user identification data;
a vehicle repair module configured to determine an estimated cost of ownership of the vehicle based on at least the vehicle profile data;
a vehicle sales module configured to determine an estimated value of the vehicle based on at least the vehicle profile data; and
a lead generation module configured to generate a vehicle service lead by transmitting the user identification data to a vehicle lead receipt system associated with a vehicle repair organization and is configured to support generation of revenue based on the vehicle service lead.
